(19) United States
(12) Patent Application Publication
(10) Pub. No.: US 2018/0172025 A1
(43) Pub. Date: Jun. 21, 2018

(54) RETURN FLOW CHANNEL FORMATION PART FOR CENTRIFUGAL COMPRESSOR AND CENTRIFUGAL COMPRESSOR

(71) Applicant: MITSUBISHI HEAVY INDUSTRIES THERMAL SYSTEMS, LTD., Tokyo (JP)

(72) Inventor: Jun KOGA, Tokyo (JP)

(73) Assignee: MITSUBISHI HEAVY INDUSTRIES THERMAL SYSTEMS, LTD., Tokyo (JP)

(21) Appl. No.: 15/739,256

(22) PCT Filed: Jun. 9, 2016
(86) PCT No.: PCT/JP2016/067202

§ 371 Date: Dec. 22, 2017

(30) Foreign Application Priority Data
Oct. 30, 2015 (JP) 2015-213738

(51) Int. Cl. F04D 29/44; F04D 17/12; F04D 25/06; F04D 27/02; F04D 29/28; F04D 29/42

(52) U.S. Cl. CPC F04D 29/444; F04D 17/122; F04D 25/0606; F05D 2250/50; F04D 29/284; F04D 29/4226; F04D 27/0246

(57) ABSTRACT

A return flow channel formation part that comprises a casing (28) and a plurality of return vanes (38). The casing (28) comprises a return bend part (36) and a return flow channel (33) that has a straight flow channel (37). The straight flow channel (37) includes a hub side wall surface (W1), a shroud side wall surface (W2), and an intermediate intake port (41) that is formed in one radial-direction portion of the shroud side wall surface (W2). The angle of inclination of the hub side wall surface (W1) and/or the shroud side wall surface (W2) with respect to the radial direction in a cross-section that includes an axis line (Ar) changes at the intermediate intake port (41).

### TECHNICAL FIELD

The present invention relates to a return flow channel formation part for a centrifugal compressor and a centrifugal compression machine.

Priority is claimed on Japanese Patent Application No. 2015-213738, filed Oct. 30, 2015, the content of which is incorporated herein by reference.

### BACKGROUND ART

A turbo refrigerator is a heat source apparatus having a large capacity which is widely used for applications such as large factory air conditioning in a clean room of electrical and electronics related factories or district heating and cooling. A turbo refrigerator is known, which includes a compressor which compresses a refrigerant gas mainly using an impeller, an evaporator, a condenser, and an economizer and in which the refrigerant gas flows from the economizer into an upstream side of a second compression stage.

As the compressor, from the viewpoint of performance and a cost, in most cases, a centrifugal compressor which adopts a two-stage compression/two-stage expansion cycle is used. In this kind of centrifugal compressor, an intermediate intake port is provided on the upstream side of the second compression stage and the refrigerant gas supplied from the economizer is taken in through the intermediate intake port. In general, the intermediate intake port is provided in the vicinity of a return vane (PTL 1 below).

In order to improve compression performance in a first compression stage, in general, it is effective to increase an outlet width (a flow channel area in a downstream side end portion of the return vane) of the return vane.

### CITATION LIST

### Patent Literature

[PTL 1] Japanese Unexamined Patent Application Publication No. 2013-194687

### SUMMARY OF INVENTION

### Technical Problem

However, in the above-described compressor configured to include the intermediate intake port, as described above, in the case where only the outlet width of the return vane increases, a pressure loss increases. Accordingly, there is a possibility that required improvement in compression efficiency cannot be realized.

The present invention is made to solve the above-described problem, and an object thereof is to provide a return flow channel formation part of a centrifugal compression machine having sufficient compression efficiency.

### Solution to Problem

According to a first aspect of the present invention, a return flow channel formation part for a centrifugal compression machine includes a casing which forms a return flow channel including a return bend part which returns a fluid flowing from a radially inner side of a rotary shaft extending along an axis line toward a radially outer side thereof to the radially inner side and a straight flow channel which is connected to a downstream side of the return bend part and introduces the fluid to the radially inner side. This return flow channel formation part further includes a plurality of return vanes which are provided in a portion of the straight flow channel and are disposed with intervals therebetween in a circumferential direction. The casing includes a hub side wall surface and a shroud side wall surface forming a disposition region of the return vanes in the straight flow channel and an intermediate intake port which is formed in a portion of the shroud side wall surface in the radial direction. An inclination angle of at least one of the hub side wall surface and the shroud side wall surface in the radial direction in a cross-section including the axis line changes at the intermediate intake port as a boundary.

According to this configuration, in the straight flow channel, a portion in which a cross-sectional area of the flow channel abruptly increases is not formed. In other words, the cross-sectional area of the straight flow channel gently increases from the radially outer side toward the radially inner side about the axis line. Accordingly, it is possible to decrease the possibility of occurrence of the pressure loss in a fluid flowing through the straight flow channel.

According to a second aspect of the present invention, the hub side wall surface of the first aspect may include a hub side upstream surface which extends to retreat so as to have an inclination angle θ1 in the radial direction toward the radially inner side. The hub side wall surface may further include a hub side downstream surface which connected to the radially inner side of the hub side upstream surface and extends to retreat so as to have an inclination angle θ2 which is smaller than the inclination angle θ1 in the radial direction toward the radially inner side.

According to the above-described configuration, the hub side upstream surface has the inclination angle θ1 in the radial direction and the hub side downstream surface has the inclination angle θ2 in the radial direction. Accordingly, it is possible to gently change the cross-sectional area of the straight flow channel from the upstream side toward the downstream side.

According to a third aspect of the present invention, the shroud side wall surface of the second aspect may include a shroud side upstream surface which is disposed on the radially outer side of the intermediate intake port and extends to retreat so as to have an inclination angle θ3 in the radial direction toward the radially inner side. The shroud side wall surface may further include a shroud side downstream surface which is disposed on the radially inner side of the intermediate intake port and extends to be parallel in the radial direction.

According to the above-described configuration, it is possible to prevent an increase ratio (area increase ratio) of the cross-sectional area of the straight flow channel from excessively increasing from the radially outer side toward the radially inner side with respect to the axis line.

According to a fourth aspect, the shroud side wall surface of the second aspect may include a shroud side upstream surface which is disposed on the radially outer side of the intermediate intake port and extends to be parallel in the radial direction, and a shroud side downstream surface which is disposed on the radially inner side of the intermediate intake port and extends to be parallel in the radial direction.

According to the above-described configuration, a fluid can smoothly flow along the shroud side wall surface. In addition, according to the above-described configuration, it is possible to prevent the increase ratio (area increase ratio) of the cross-sectional area of the straight flow channel from being abruptly changed from the radially outer side toward the radially inner side with respect to the axis line.

According to a fifth aspect of the present invention, the shroud side wall surface of the first aspect may include a shroud side upstream surface which is disposed on the radially outer side of the intermediate intake port and extends to retreat so as to have an inclination angle θ4 in the radial direction toward the radially inner side. The shroud side wall surface may further include a shroud side downstream surface which is disposed on the radially inner side of the intermediate intake port and extends to retreat so as to have an inclination angle θ5 which is smaller than the inclination angle θ4 in the radial direction toward the radially inner side.

According to the above-described configuration, the hub side upstream surface has the inclination angle θ4 in the radial direction and the hub side downstream surface has the inclination angle θ5 in the radial direction. Accordingly, it is possible to gently change the cross-sectional area of the straight flow channel from the upstream side toward the downstream side. In addition, according to the above-described configuration, it is possible to r prevent an increase ratio (area increase ratio) of the cross-sectional area of the straight flow channel from excessively increasing from the radially outer side toward the radially inner side with respect to the axis line.

According to a sixth aspect of the present invention, the hub side wall surface of the fifth aspect may extend to be parallel in the radial direction.

According to the above-described configuration, a fluid can smoothly flow along the shroud side wall surface. In addition, according to the above-described configuration, it is possible to prevent the increase ratio (area increase ratio) of the cross-sectional area of the straight flow channel from being abruptly changed from the radially outer side toward the radially inner side about the axis line.

According to a seventh aspect, there is provided a centrifugal compression machine including a rotary shaft which rotates around an axis line; an impeller which is provided on the rotary shaft and rotates around the axis line; and the return flow channel formation part of a centrifugal compression machine according to any one of the first to sixth aspects in which the impeller is provided on an outer peripheral side.

According to the above-described configuration, it is possible to provide the centrifugal compressor having sufficient compression efficiency

### Advantageous Effects of Invention

According to the return flow channel formation part of a centrifugal compression machine and the centrifugal compression machine, it is possible to provide the return flow channel formation part of a centrifugal compression machine and the centrifugal compression machine having sufficient compression efficiency.

### BRIEF DESCRIPTION OF DRAWINGS

FIG. 1 is a configuration diagram showing a turbo refrigerator according to a first embodiment of the present invention.

FIG. 2 is a sectional view taken along a plane including an axis line of a centrifugal compressor according to the first embodiment of the present invention.

FIG. 3 is an enlarged sectional view of a main part of the centrifugal compressor according to the first embodiment of the present invention.

FIG. 4 is a graph showing an example of an increase ratio of a cross-sectional area of a return flow channel according to the first embodiment of the present invention.

FIG. 5 is an enlarged sectional view of a main part of a centrifugal compressor according to a second embodiment of the present invention.

FIG. 6 is an enlarged sectional view of a main part of a centrifugal compressor according to a third embodiment of the present invention.

### DESCRIPTION OF EMBODIMENTS

### First Embodiment

Hereinafter, a turbo refrigerator 1 (centrifugal compression machine) according to a first embodiment of the present invention will be described with reference to the drawings.

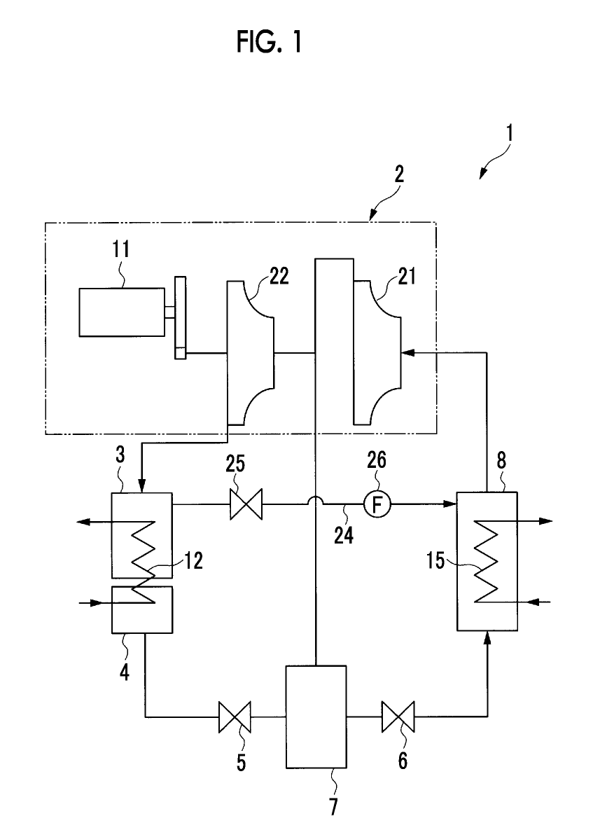

As shown in FIG. 1, the turbo refrigerator 1 according to the present embodiment includes a compressor 2, a condenser 3, a subcooler 4, a high-pressure expansion valve 5, an economizer 7 (intercooler), and an evaporator 8.

The compressor 2 compresses a refrigerant.

The condenser 3 condenses a high-temperature and high-pressure refrigerant gas generated by the compressor 2.

The subcooler 4 performs supercooling processing on a liquid-phase refrigerant (liquid refrigerant) condensed by the condenser 3.

The high-pressure expansion valve 5 expands the liquid refrigerant from the subcooler 4.

The economizer 7 (intercooler) is connected to the high-pressure expansion valve 5 and is connected to an intermediate stage of the compressor 2 and the low-pressure expansion valve 6.

The evaporator 8 evaporates the liquid refrigerant expanded by the low-pressure expansion valve 6.

The compressor 2 is a two-stage centrifugal compressor. This compressor 2 includes a low-pressure side first impeller 21 and a high-pressure side second impeller 22. The compressor 2 is driven by an electric motor 11 of which the rotating speed is controlled by an inverter which changes input frequencies from a power source.

The subcooler 4 is provided on a refrigerant gas downstream side of the condenser 3. The subcooler 4 is used to apply supercooling to the condensed refrigerant. A cooling heat transfer tube 12 for cooling the condenser 3 and the subcooler 4 is inserted into the condenser 3 and the subcooler 4. Cooling water flows through the inside of the cooling heat transfer tube 12. The refrigerant gas comes into contact with the cooling heat transfer tube 12 and thus, the refrigerant gas is condensed.

The evaporator 8 generates a refrigerant gas having a predetermined rated temperature by heat absorption of cold water. A cold water heat transfer tube 15 is inserted into the evaporator 8.

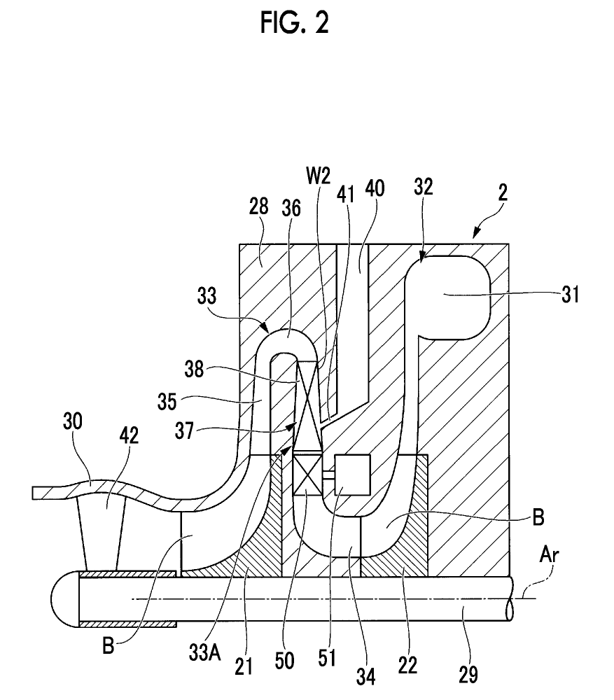

Next, a detailed configuration of the centrifugal compressor 2 will be described with reference to FIG. 2.

As shown in FIG. 2, the centrifugal compressor 2 includes a rotary shaft 29, a motor (not shown), a first impeller 21, a second impeller 22, and a casing 28.

The rotary shaft 29 extends along an axis line Ar and is rotatable around the axis line Ar.

The motor (not shown) rotationally drives the rotary shaft 29.

The first impeller 21 and the second impeller 22 are provided on the rotary shaft 29 to be separated from each other in the direction of the axis line Ar.

The casing 28 covers the first impeller 21 and the second impeller 22 from the outer peripheral side.

An intake port 30 into which a refrigerant gas flows from the outside is provided on a first side of the casing in the direction of the axis line Ar. A scroll 31 which discharges the refrigerant gas is provided on a second side of the casing 28 in the direction of the axis line Ar. An internal space 32 which communicates with the intake port 30 and the scroll 31 is formed in the casing 28.

The first impeller 21 and the second impeller 22 are disposed in the internal space 32. The first impeller 21 forms a first compression stage and the second impeller 22 forms a second compression stage. The first impeller 21 and the second impeller 22 includes a plurality of blades B which extend from the inside toward the outside in a radial direction about the axis line Ar. In the following descriptions, the “radial direction about the axis line Ar” is simply referred to as a “radial direction”.

The plurality of blades B are arranged with intervals therebetween in a circumferential direction about the axis line Ar.

A flow channel through which the refrigerant gas flows is formed between the pair of blades B adjacent to each other in the circumferential direction. The flow channel is curved such that the refrigerant gas gradually flows from the radially inner side to the radially outer side from the first side toward the second side in the direction of the axis line Ar. In the following descriptions, in both end portions of the flow channel formed by the blades B, a side (the first side in the direction of the axis line Ar) into which the refrigerant gas flows is referred to as an upstream side, a hub side, or the like. Moreover, in the following descriptions, a side (the second side in the direction of the axis line Ar) to which the refrigerant gas flows is referred to as a downstream side, a shroud side, or the like.

The internal space 32 includes a return flow channel 33 and an intake flow channel 34 (inflow flow channel 34).

The return flow channel 33 is connected to the downstream side of the flow channel formed by the first impeller 21.

The intake flow channel 34 (inflow flow channel 34) connects the return flow channel 33 and the flow channel formed by the second impeller 22 to each other. The intake flow channel 34 is connected to the upstream side of the flow channel formed by the second impeller 22.

In descriptions below, particularly, a substantive part of the centrifugal compressor 2 forming the return flow channel 33 is referred to as a return flow channel formation part 33A. That is, the return flow channel 33 includes a portion of the casing 28 which is the return flow channel formation part 33A.

In the return flow channel 33, the refrigerant gas flows from a flow channel outlet of the first impeller 21 disposed on the radially outer side toward a flow channel inlet of the second impeller 22 disposed on the radially inner side. The return flow channel 33 (return flow channel formation part 33A) includes a diffuser 35, a return bend part 36, a straight flow channel 37, return vanes 38, and an intermediate intake port 41.

The diffuser 35 guides the refrigerant gas compressed by the first impeller 21 to the radially outer side. A flow channel area of the diffuser 35 when viewed in the radial direction gradually increases from the radially inner side toward the radially outer side. Both wall surfaces of the diffuser 35 in the direction of the axis line Ar extend to be parallel to each other from the radially inner side toward the radially outer side on a cross-section including the axis line Ar. After an end portion outside the diffuser 35 in the radial direction is reverted toward the radially inner side via the return bend part 36, the end portion communicates with the straight flow channel 37. Both wall surfaces of the diffuser 35 in the direction of the axis line Ar need not necessarily to be completely parallel to each other as long as both wall surfaces are substantially parallel to each other.

The return bend part 36 is curved such that the center portion thereof protrudes toward the radially outer side on the cross-section including the axis line Ar. In other words, the return bend part 36 is formed in an arc shape which connects the outlet of the diffuser 35 and the inlet of the straight flow channel 37 to each other.

The straight flow channel 37 extends from the downstream side end portion of the return bend part 36 toward the radially inner side. In the straight flow channel 37, the plurality of return vanes 38 are radially arranged about the axis line Ar. The refrigerant gas (fluid) is introduced to the radially inner side by the straight flow channel.

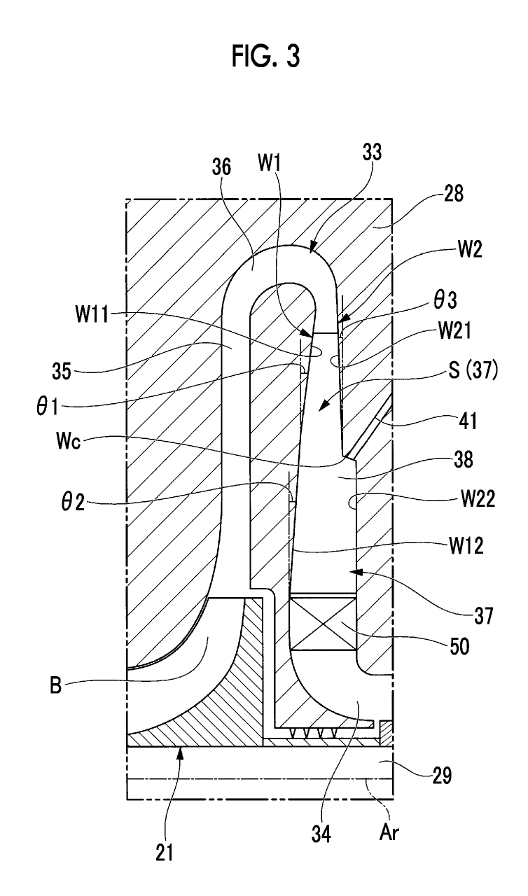

As shown in FIG. 3, a pair of wall surfaces forming the straight flow channel 37 on the cross-section including the axis line Ar each becomes a hub side wall surface W1 and a shroud side wall surface W2. That is, the hub side wall surface W1 becomes a first side wall surface of the straight flow channel 37 in the direction of the axis line Ar. The shroud side wall surface W2 is a second wall surface of the straight flow channel 37 in the direction of the axis line Ar. The hub side wall surface W1 and the shroud side wall surface W2 face each other in the direction of the axis line Ar. The hub side wall surface W1 and the shroud side wall surface W2 form a disposition region S in which the return vanes 38 are disposed.

In the intake flow channel 34 (that is, the flow channel inlet of the second impeller 22) of the return flow channel 33, movable vanes 50 of which angles can be changed according to an operation situation are provided. The plurality of movable vanes 50 are arranged with intervals therebetween in the circumferential direction with respect to the axis line Ar. The plurality of movable vanes 50 are driven by a drive device 51 (refer to FIG. 2), and thus, the angles thereof are changed.

As shown in FIG. 2, an intermediate intake chamber 40 is provided at an intermediate position of the shroud side wall surface W2. In the straight flow channel 37, the intermediate intake chamber 40 combines the refrigerant gas generated by the economizer 7 to a discharged flow of the first impeller 21. The intermediate intake chamber 40 is an annular space which surrounds the vicinity of the inlet portion of the second impeller 22. A slit-shaped intermediate intake port 41 is provided on the radially inner side of the intermediate intake chamber 40. The intermediate intake port 41 connects the inside of the intermediate intake chamber 40 and the straight flow channel 37 of the return flow channel to each other. In the shroud side wall surface W2, a region in which one end (outlet) of the intermediate intake port 41 is provided becomes a connection wall surface Wc described below.

As shown in FIG. 3, in the present embodiment, when viewed from the cross-section including the axis line Ar, the hub side wall surface W1 and the shroud side wall surface W2 in the straight flow channel 37 are inclined at different angles in the radial direction about the axis line Ar at the one end (outlet) of the intermediate intake port 41 as a boundary.

More specifically, the hub side wall surface W1 includes a hub side upstream surface W11 and a hub side downstream surface W12. The hub side upstream surface W11 is formed in a region on the radially outer side from the position of the one end (outlet) of the intermediate intake port 41 of the hub side wall surface W1 in the radial direction. In addition, the hub side upstream surface W1 has an inclination angle θ1 which is relatively large in the radial direction. The hub side downstream surface W12 is connected to the radially inner side of the hub side upstream surface W11 and has an inclination angle θ2 which is relatively smaller than the inclination angle in the radial direction. The above-described inclination angles in the radial direction mean inclination angle with respect to a virtual plane orthogonal to the axis line Ar. Similarly, in the following descriptions, the “being parallel in the radial direction” means being parallel to the virtual plane orthogonal to the axis line Ar.

The hub side upstream surface W11 extends to retreat to have the inclination angle θ1 in the radial direction from the radially outer side toward the radially inner side. In other words, the hub side upstream surface W11 extends to retreat toward the first side in the direction of the axis line Ar from the radially outer side toward the radially inner side.

The hub side downstream surface W12 extends to retreat to have the inclination angle θ2 in the radial direction from the radially outer side toward the radially inner side. In other words, the hub side downstream surface W12 extends to retreat toward the first side in the direction of the axis line Ar from the radially outer side toward the radially inner side.

The shroud side wall surface W2 includes a shroud side upstream surface W21, a connection wall surface Wc, and a shroud side downstream surface W22. The shroud side upstream surface W21 is formed in a region on the radially outer side from the position of the one end (outlet) of the intermediate intake port 41 in the radial direction and has an inclination angle θ3 which is relatively large in the radial direction. The connection wall surface Wc is a wall surface on which the one end (outlet) of the intermediate intake port 41 is formed. The shroud side downstream surface W22 is positioned on the radially inner side from the shroud side upstream surface W21 and has an inclination angle which is relatively small in the radial direction. Here, the inclination angles indicate inferior angles among the angles formed by wall surfaces in the radial direction of the axis line Ar (refer to θ1, θ2, and θ3 in FIG. 3).

The shroud side upstream surface W21 retreats to have the inclination angle θ3 in the radial direction from the radially outer side toward the radially inner side. In other words, the shroud side upstream surface W21 extends to retreat toward the second side in the direction of the axis line Ar from the radially outer side toward the radially inner side. In the present embodiment, the shroud side downstream surface W22 is formed to be parallel in the radial direction. In other words, the hub side downstream surface W12 extends in the direction orthogonal to the axis line Ar.

That is, the hub side upstream surface W11 and the shroud side upstream surface W21 are gradually separated from each other from the radially outer side toward the radially inner side on the cross-section including the axis line Ar.

Since the inclination angle θ1 is greater than the inclination angle θ2, angles formed by the hub side upstream surface W11 and the hub side downstream surface W12 facing the inside of the straight flow channel 37 are smaller than 180° and is greater than 90°.

In order to improve compression performance in the first compression stage, in general, it is effective to increase the outlet width (flow channel area on the downstream side end portion of the return vane 38) of the return vane 38. However, as described above, in the centrifugal compressor 2 having the intermediate intake port 41, in a case where only the outlet width of the return vane 38 increases, the cross-sectional area of the flow channel abruptly increases, and thus, a pressure loss increases. Accordingly, there is a possibility that required improvement in the compression efficiency cannot be realized.

However, according to the above-described configuration, in the straight flow channel 37, a portion in which the cross-sectional area of the flow channel abruptly increases is not formed. In other words, the cross-sectional area of the straight flow channel 37 gently increases from the radially outer side toward the radially inner side. Accordingly, it is possible to decrease the possibility of occurrence of the pressure loss in the refrigerant gas (fluid) flowing through the straight flow channel 37.

Accordingly, it is possible to sufficiently improve the compression efficiency of the centrifugal compressor 2.

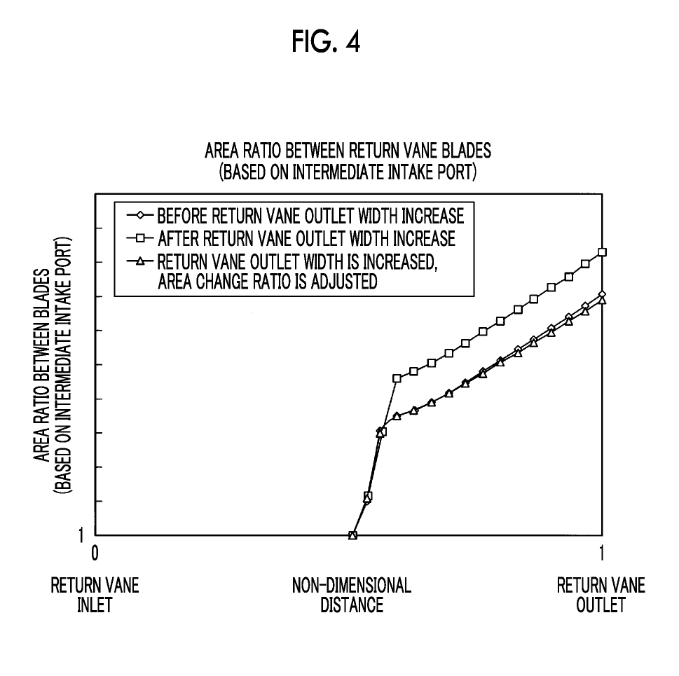

In addition, according to the above-described configuration, it is possible to prevent an increase ratio (an area increase ratio) in the cross-sectional area of the straight flow channel 37 from excessively increasing from radially outer side toward the radially inner side (refer to FIG. 4). Particularly, as shown in FIG. 4, in a case where the flow channel width increase on only the end portion on the outlet side of the return vane 38 (refer to FIG. 3), there is a concern that the area increase ratio greatly increases.

However, in the present embodiment, in addition to the increase in the outlet width of the return vane 38, as described above, the upstream surfaces (hub side upstream surface W11 and shroud side upstream surface W21) and the downstream surfaces (hub side downstream surface W12 and the shroud side downstream surface W22) having inclined portions are provided, and thus, it is possible to increase the outlet width of the return vane 38 compared to the previous one without changing the area increase ratio. Accordingly, it is possible to further improve the compression efficiency of the centrifugal compressor 2.

### Second Embodiment

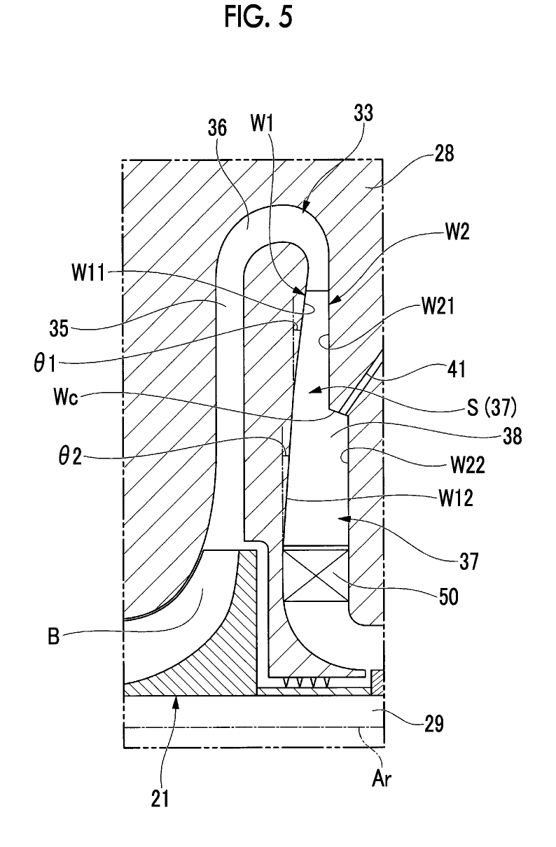

Next, a second embodiment of the present invention will be described with reference to FIG. 5. The same reference numerals are assigned to the configurations similar to those of the first embodiment, and detail descriptions thereof are omitted.

As shown in FIG. 5, in the present embodiment, the hub side upstream surface W11 and the hub side downstream surface W12 each form the inclination angles θ1 and θ2 in the radial direction. More specifically, the hub side upstream surface W11 extends to retreat to have the inclination angle θ1 in the radial direction from the radially outer side toward the radially inner side. That is, the hub side upstream surface W11 extends to retreat toward the first side in the direction of the axis line Ar from the radially outer side toward the radially inner side.

The hub side downstream surface W12 extends to retreat to have the inclination angle θ2 in the radial direction from the radially outer side toward the radially inner side. That is, the hub side downstream surface W12 extends to retreat toward the first side in the direction of the axis line Ar from the radially outer side toward the radially inner side. The inclination angle θ1 is greater than the inclination angle θ2. In the present embodiment, both the shroud side upstream surface W21 and the shroud side downstream surface W22 are parallel in the radial direction.

That is, only the hub side wall surface W1 is inclined in the radial direction, and a portion of the shroud side wall surface W2 except for the connection wall surface Wc extends to be parallel in the radial direction.

According to the above-described configuration, it is possible to further prevent an increase ratio (area increase ratio) of the cross-sectional area of the straight flow channel 37 from excessively increasing from the radially outer side toward the radially inner side with respect to the axis line Ar. In addition, compared to the case where both the hub side wall surface W1 and the shroud side wall surface W2 are inclined, it is possible to easily perform design or machining of members.

### Third Embodiment

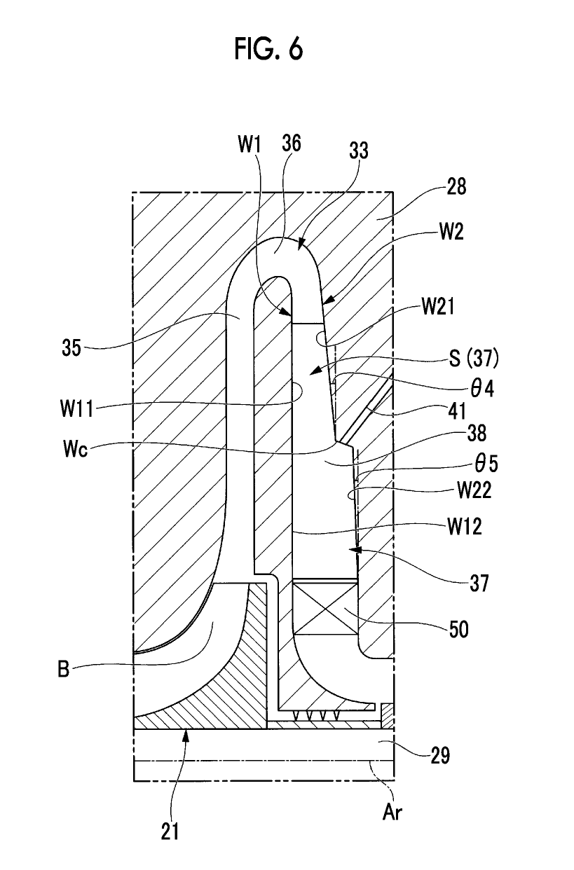

A third embodiment of the present invention will be described with reference to FIG. 6. The same reference numerals are assigned to the configurations similar to those of the first and second embodiments, and detail descriptions thereof are omitted.

As shown in FIG. 6, in the present embodiment, the entire region of the hub side wall surface W1 in the radial direction extends to be parallel in the radial direction. That is, the hub side upstream surface W11 and the hub side downstream surface W12 continue to each other to be disposed on the same plane as each other. In the shroud side wall surface W2, the shroud side upstream surface W21 and the shroud side downstream surface W22 each have the inclination angles θ4 and 05 in the radial direction. More specifically, the shroud side upstream surface W21 extends to retreat to have the inclination angle θ4 in the radial direction from the radially outer side toward the radially inner side. That is, the shroud side upstream surface W21 extends to retreat toward the second side in the direction of the axis line Ar from the radially outer side toward the radially inner side.

The shroud side downstream surface W22 extends to retreat to have the inclination angle θ5 in the radial direction from the radially outer side toward the radially inner side. That is, the shroud side downstream surface W22 extends to retreat toward the second side in the direction of the axis line Ar from the radially outer side toward the radially inner side.

The inclination angle θ5 is smaller than the inclination angle θ4.

According to the above-described configuration, it is possible to prevent an increase ratio (area increase ratio) of the cross-sectional area of the straight flow channel 37 from excessively increasing from the radially outer side toward the radially inner side. In addition, compared to the case where both the hub side wall surface W1 and the shroud side wall surface W2 are inclined, it is possible to easily perform design or machining of members.

### INDUSTRIAL APPLICABILITY

The present invention can be applied to the return flow channel formation part of a centrifugal compression machine and the centrifugal compression machine, and it is possible to decrease a possibility of the occurrence of the pressure loss in the fluid flowing through the straight flow channel.

### REFERENCE SIGNS LIST

1: turbo refrigerator, 2: compressor (centrifugal compressor, centrifugal compression machine), 3: condenser, 4: subcooler, 5: high-pressure expansion valve, 6: low-pressure expansion valve, 7: economizer, 8: evaporator, 11: electric motor, 12: cooling heat transfer tube, 15: cold water heat transfer tube, 21: first impeller, 22: second impeller, 28: casing, 29: rotary shaft, 30: intake port, 31: scroll, 32: internal space, 33: return flow channel, 34: intake flow channel (inflow flow channel), 35: diffuser, 36: return bend part, 37: straight flow channel, 38: return vane, 40: intermediate intake chamber, 41: intermediate intake port, 50: movable vane, 51: drive device, 33A: return flow channel formation part, Ar: axis line, B: blade, S: disposition region, W1: hub side wall surface, W11: hub side upstream surface, W12: hub side downstream surface, W2: shroud side wall surface, W21: shroud side upstream surface, W22: shroud side downstream surface, Wc: connection wall surface, θ1, θ2, θ3: inclination angle

1. A return flow channel formation part for a centrifugal compressor, comprising:
a casing which forms a return flow channel including a return bend part which returns a fluid flowing from a radially inner side of a rotary shaft extending along an axis line toward a radially outer side thereof to the radially inner side and a straight flow channel which is connected to a downstream side of the return bend part and introduces the fluid to the radially inner side; and
a plurality of return vanes which are provided in a portion of the straight flow channel and are disposed with intervals therebetween in a circumferential direction,
wherein the casing includes a hub side wall surface and a shroud side wall surface forming a disposition region of the return vanes in the straight flow channel and an intermediate intake port which is formed in a portion of the shroud side wall surface in the radial direction, and
wherein an inclination angle of at least one of the hub side wall surface and the shroud side wall surface in the radial direction in a cross-section including the axis line changes at the intermediate intake port as a boundary.

2. The return flow channel formation part for a centrifugal compressor according to claim 1,
wherein the hub side wall surface includes
a hub side upstream surface which extends to retreat so as to have an inclination angle θ1 in the radial direction toward the radially inner side and
a hub side downstream surface which connected to the radially inner side of the hub side upstream surface and extends to retreat so as to have an inclination angle θ2 which is smaller than the inclination angle θ1 in the radial direction toward the radially inner side.

3. The return flow channel formation part for a centrifugal compressor according to claim 2,
wherein the shroud side wall surface includes
a shroud side upstream surface which is disposed on the radially outer side of the intermediate intake port and extends to retreat so as to have an inclination angle θ3 in the radial direction toward the radially inner side, and
a shroud side downstream surface which is disposed on the radially inner side of the intermediate intake port and extends to be parallel in the radial direction.

4. The return flow channel formation part for a centrifugal compressor according to claim 2,
wherein the shroud side wall surface includes
a shroud side upstream surface which is disposed on the radially outer side of the intermediate intake port and extends to be parallel in the radial direction, and
a shroud side downstream surface which is disposed on the radially inner side of the intermediate intake port and extends to be parallel in the radial direction.

5. The return flow channel formation part for a centrifugal compressor according to claim 1,
wherein the shroud side wall surface includes
a shroud side upstream surface which is disposed on the radially outer side of the intermediate intake port and extends to retreat so as to have an inclination angle θ4 in the radial direction toward the radially inner side, and
a shroud side downstream surface which is disposed on the radially inner side of the intermediate intake port and extends to retreat so as to have an inclination angle θ5 which is smaller than the inclination angle θ4 in the radial direction toward the radially inner side.

6. The return flow channel formation part for a centrifugal compressor according to claim 5,
wherein the hub side wall surface extends to be parallel in the radial direction.

7. A centrifugal compressor, comprising:
a rotary shaft which rotates around an axis line;
an impeller which is provided on the rotary shaft and rotates around the axis line; and
the return flow channel formation part according to claim 1 in which the impeller is provided on an outer peripheral side.
